(19) United States
(12) Patent Application Publication
(10) Pub. No.: US 2023/0234002 A1
(43) Pub. Date: Jul. 27, 2023

(54) OIL AND WATER SEPARATION MEMBRANE

(71) Applicant: G20 Water Technologies Limited, Manchester (GB)

(72) Inventors: Kangsheng LIU, Manchester (GB); Fan FEI, Manchester (GB); Tom PUGH, Manchester (GB)

(21) Appl. No.: 17/927,541

(22) PCT Filed: May 27, 2021
(86) PCT No.: PCT/GB2021/051276

§ 371 Date: Nov. 23, 2022

(30) Foreign Application Priority Data
May 27, 2020 (GB) 2007914.1

(51) Int. Cl. B01D 69/12; B01D 67/00; B01D 69/02; B01D 71/12; B01D 71/40; B01D 71/70; B01D 71/76; C02F 1/40; C02F 1/44

(52) U.S. Cl. CPC B01D 69/125; B01D 67/0006; B01D 69/02; B01D 71/12; B01D 71/401; B01D 71/70; B01D 71/76; C02F 1/40; C02F 1/44; B01D 2325/36; B01D 2323/02; B01D 2323/30; B01D 2323/36; C02F 2101/32

(57) ABSTRACT

A separation membrane, such as for pressure-assisted oil and water separation. The membrane includes a porous substrate layer and an active layer arranged over at least a part of the substrate layer. The active layer is at least partially crosslinked and comprises a superhydrophilic agent. Also described is a method of producing the separation membrane and a drain valve comprising the membrane.

### FIELD

The present invention relates to a membrane for oil and water separation. In particular, the present invention relates to a membrane for oil and water separation in fuel tanks.

### BACKGROUND

In the aviation industry, water ingress into jet fuel has been a well-known and challenging problem. Water can enter the fuel tank during normal operations such as the adjustment of fuel tank pressure to atmospheric pressure when the tank is opened, and humid warm air enters the tank via the opening. The moisture may mix with jet fuel, condense within the tank and settle in the tank. This may also happen with other types of fuel tank which have an opening mechanism to drain or fill the tank or where fuel is stored in partially filled tanks under an air atmosphere which contains moisture for example marine and auto fuel tanks. For example, filling auto and marine fuel tanks may allow water ingress into the fuel.

Water ingress into fuel tanks, such in aircrafts, ships and boats, and other hydrocarbon-based transportation, can cause several serious problems. It may affect both the fuel tank and its surrounding systems including instrumentation. Such as corrosion of the tank's interior walls, reducing the life span of the tank, and potentially affecting the quality of fuel. In the presence of water, bio-organisms may also grow and facilitate the corrosion process by releasing corroding chemicals as well as directly causing engine failure through blockage. Water ingress also reduces the amount of fuel being carried and further wastes energy carrying the undesired water. Moreover, if water enters the fuel delivery system or engine chamber, more serious problems could be caused, such as damage and corrosion to the engine and/or the whole system, resulting in more severe outcomes. Water freezes at high altitude, forming ice in fuel tanks, which may cause engine failure when the ice enters the engine system, potentially resulting in a forced landing or crash, such as the accident involving British Airways, Boeing 3777, flight 38 on 17 Jan. 2008.

Current methods for water removal and prevention of water build-up on planes include preventive maintenance such as regular drainage of fuel tanks and installation of a water scavenging system.

On commercial aircraft the water scavenging system normally consists of jet pumps which are operated by motive flow from the fuel booster pumps. The fluid at the bottom of the tank is drawn by the jet pumps and injected close to the inlet of each fuel booster pump. One of the main disadvantages of the system is that the scavenge pumps will not operate when the fuel booster pump is not operating. This could cause water accumulation inside the tank due to condensation and moisture entering the tanks through fuel vent ports when the planes are at station.

Another disadvantage of this system is that water in fuel can freeze below 0° C. and the resulting ice crystals may enter and then block the scavenge pump, and cause failure in the scavenge system.

A further disadvantage of using such a scavenge system is the undesired weight, causing fuel inefficiency.

In most aircraft fuel systems, there are a number of fuel/water drain valves which are used to drain water accumulated at the bottom of the fuel tanks usually located on the underside of the wings. However, this drainage method has several disadvantages.

One of the main disadvantages is that when a valve is defective, it requires the whole tank to be drained of fuel and purged with dry air which could take up to 24 hours. Another disadvantage is that water cannot be drained in cold weather because as the water freezes it will be retained as ice in the tank. In addition, it is also labour intensive requiring manual operation of the valves typically from an elevated platform and exposes the operator to fuel vapours and is thus not optimal in terms of safety, time and economy for routine maintenance.

It is therefore desirable that an improved system for water separation from oil in fuel tanks should comprise one or a combination of the following features: high separation efficiency; reliability, low maintenance, light weight; simplicity to operate and maintain; and/or have high structural integrity into fuel tanks or any drainage valves. The system should also be commercially accessible to industry, such as, low material and manufacturing costs, readily produced using industrially established raw materials and processes and be capable of being retrofitted into current fuel drain valve housings.

In some applications it is desirable to have a membrane water separation device which operates under transmembrane pressures of up to 5 bar. For example, higher operational pressures may be reached on over-filling of fuel tanks, during aircraft landing or emergency landing, and other applications such as pressure assisted system to increase the flux. In such scenarios the transmembrane pressure (pressure difference between the fuel side and the other side) could reach as high 5 bar. A membrane that works under such high pressure is therefore desirable.

Therefore, there is a requirement for an improved system for tackling water contaminated fuel in aircraft, as well as other fuel tanks, under desired elevated operational pressure. It is therefore an object of the present invention to address one or more of the abovementioned, or other, problems.

### SUMMARY

According to a first aspect of the present invention, there is provided a separation membrane, such as for pressure-assisted oil and water separation, comprising a porous substrate layer and an active layer arranged over at least a part of the substrate layer, wherein the active layer is at least partially crosslinked and comprises a superhydrophilic agent.

According to a second aspect of the present invention, there is provided a method of producing a separation membrane, suitably a membrane according to the first aspect of the invention, the method comprising the steps of:
a. optionally, preparing a substrate by treating the substrate with physical rinsing, chemical treatment, radiation treatment, plasma treatment, and/or thermal treatment;
b. optionally, contacting the substrate with an intermediate layer coating composition to form an intermediate layer;
c. optionally, contacting the substrate with a coating composition comprising a hydrophilic agent or precursor thereof to form an active layer;
d. optionally, drying the active layer;
e. optionally, contacting the active layer with an intermediate layer coating composition to form an intermediate layer;
f. contacting the optionally coated substrate with a coating composition comprising a superhydrophilic agent or precursor thereof to form an active layer;
g. optionally, drying the further active layer;

wherein the active layer comprising the superhydrophilic agent is at least partially crosslinked.

According to a third aspect of the present invention, there is provided a method of separating oil and water, comprising the steps of:
a. selecting a membrane comprising a porous substrate layer and an active layer arranged over at least a part of the substrate layer, wherein the active layer is at least partially crosslinked and comprises a superhydrophilic agent, suitably a membrane according to the first or second aspect of the present invention;
b. contacting the membrane with composition comprising oil and water; and
c. effecting separation of the oil and water through the membrane,

wherein the average pore size of the substrate is selected based on the operational pressure such that the substrate has a lower average pore size at higher operational pressure to give a membrane with a water flux of ≥100 lmh/bar during separation of the oil and water through the membrane.

According to a fourth aspect of the present invention there is provided the use of a coating composition comprising a superhydrophilic agent or precursor thereof in the manufacture of a separation membrane, such as a membrane according to any of the first to third aspects of the present invention.

The coating composition of the fourth aspect may be for use in deposition on the separate membrane, such as gravity, pressure or vacuum deposition. The composition may be for use on pre-coated membranes.

According to a fifth aspect of the present invention, there is provided the use of a membrane according to any of the first to third aspects of the present invention in a pressure-assisted separation, such as a pressure-assisted oil and water separation.

According to a sixth aspect of the present invention there is provided a drainage device, suitably a drain valve for a fuel tank comprising a membrane according to the first or second aspect of the present invention.

According to a seventh aspect of the present invention there is provided a fuel tank comprising a drain valve, wherein the drain valve comprises a membrane according to the first or second aspect of the present invention.

According to a eighth aspect of the present invention there is provided an automotive product or any part thereof comprising a fuel tank that comprises a drain valve, wherein the drain valve comprises a membrane according to the first or second aspect of the present invention.

The membrane may be for use in a fuel tank, such as the fuel tank of a transport vehicle, for example a marine or aviation vehicle fuel tank. The membrane may be for fuel and water separation, such as kerosene and water separation.

Advantageously, the membrane of the present invention may be used to separate water from oil or fuel without the requirement for pre-wetting the membrane with water. The prepared membrane may be applied to separate water from oil without prewetting with water, preventing transfer of oil through the membrane for an extended time period, such as longer than 1 day, 10 days, or 50 days. As such, the membrane of the present invention is activated in the dry state. This is in contrast to prior art membranes which require pre-wetting with water to activate the membranes before separation. Accordingly, the membrane may be supplied without a requirement of the end-user to pre-activate the membrane, which can complicate the installation process. The membrane is also able to continue to operate even when it has not been exposed to water for a long period of time, improving ease of use.

In addition, membranes of the present invention are able provide improved separation under higher pressures (e.g. 2-3 bars) with reduced leakage, which can occur with prior art membranes due to over-filling of the fuel tank for example, and also in pressure-assisted separation applications where pressure (e.g. 1 to 2 bar) may be used to increase water flux rates to reduce the time to complete water oil separation.

The membrane of the present invention provides a separation system that is light weight and easy to operate and maintain while also providing a high separation efficiency and having a high structural integrity. In addition, the membrane of the present invention may advantageously be operated with low or no energy input.

The active layer may be operable to provide a separation effect. As such, the active layer may be operable to selectively promote passage of some of the material to be separated through the member while restricting passage of other material.

The membrane may comprise at least two active layers. For example, should the membrane comprise a hydrophilic agent and a superhydrophilic agent then the hydrophilic agent and the superhydrophilic agent may or may not be contained in the same active layer, or in the same coating composition for forming an active layer. For example, the membrane may comprise a first active layer that comprises a hydrophilic agent, and a second active layer that comprises a superhydrophilic agent. Suitably, the first active layer is hydrophilic and the second active layer is superhydrophilic.

The second active layer may be arranged over at least a part of the first active layer. The membrane may comprise intermediate layers arranged between the active layers and/or an intermediate layer arranged between the active layer and the substrate.

The membrane may comprise at least two layers of the first and/or second active layers. Suitably, the membrane comprises a series of layers according to the first active layer arranged below a series of layers according to the second active layer. The series of first and/or second active layers may comprise of from 2 to 20 layers, such as from 2 to 15 layers, preferably from 2 to 7 layers. The membrane may comprise of up to three active layers that comprise a hydrophilic agent.

The active layer may be formed from a coating composition, such as a coating composition comprising the superhydrophilic agent or precursor thereof.

The first active layer may be formed from a first active layer coating composition comprising the hydrophilic agent. The second active layer may be formed from a second active layer coating composition comprising the superhydrophilic agent.

Suitably, the at least partially crosslinked active layer comprising a superhydrophilic agent is on the upper face of the membrane such that it is operable to contact the separation mixture in use.

The substrate layer of any aspect of the present invention may comprise any porous material operable to support the active layer(s) during the filtration process. The substrate may comprise one layer or multiple layers.

The substrate may be in the form of a porous film, porous woven filament substrate, porous mesh, porous plate, porous tubular fibre substrate, porous hollow fibre substrate, bulky porous material, preferably in the form of a porous mesh or porous woven filament substrate or porous non-woven substrate, preferably porous woven filament substrate.

The substrate may comprises a polymeric substrate, a polymeric substrate containing inorganic filler, a ceramic substrate, a composite substrate, a metal substrate, such as a metal mesh substrate, an inorganic substrate, inorganic-organic substrate, such as woven filament such as a woven mono-filament or a woven multi-filament, and/or non-woven, and/or a casted substrate.

A polymeric porous substrate may be formed from materials selected from polyacrylonitrile (PAN), polyester such as polyethylene terephthalate (PET), polycarbonate (PC), polyamide (PA), poly(ether) sulfone (PES), polybutylene terephthalate (PBT), polysulfone (PSf), polypropylene (PP), cellulose acetate (CA), poly(piperazine-amide), polyvinylidene difluoride (PVDF), polytetrafluoroethylene (PTFE), chlorinated polyvinyl chloride (CPUC), poly(phthalazinone ether sulfone ketone) (PPESK), polyamide-urea, polyether ether ketone (PEEK), poly(phthalazinone ether ketone), and thin film composite porous films (TFC), suitably the TFC comprises an ultra-thin ‘barrier’ layer polymerised in situ over a porous polymeric support membrane, such as commercially available polyamide derived TFCs of an interfacially synthesized polyamide formed over a polysulfone (PSf) membrane, and/or others TFCs such as poly(piperazine-amide)/poly(vinyl-alcohol) (PVA), poly(piperazine-amide)/poly(phthalazinone biphenyl ether sulfone (PPBES), hydrolyzed cellulose tri-acetate (CTA)/cellulose acetate (CA) TFCs. Preferably polyethylene terephthalate-based (PET) membrane, such as poly(ether) sulfone (PES) and polyethylene terephthalate/polypropylene.

The porous substrate may be a nanotechnology-based porous substrate, such as nanostructured ceramic porous substrate, inorganic-organic porous substrate and/or non-woven nano-porous fabric.

The substrate may be inorganic and selected from stainless-steel mesh, copper mesh, alloy mesh, aluminium mesh, such as ceramic substrate, such as alumina substrate, silicon carbide substrate, and/or zirconia substrate, such as titanium oxide substrate, such as zeolite, preferably metal mesh and alumina substrate.

Metal mesh may be used as substrate, such as stainless-steel metal mesh, for example with a mesh number ranging from 50 to 1000, such as 60 to 900, such as 70 to 800, suitably 80 to 700.

The substrate may comprise a porous alumina membrane, for example with pore sizes ranging from 1 nm to 200,000 nm, such as 10 nm to 150,000 nm, 100 nm to 100,000 nm, such as 500 nm to 50,000 nm, preferably 800 nm to 30,000 nm. The substrate may comprise more than one layer having different or same pore sizes, such as a two-layer substrate comprising of one layer of alumina having 800 nm pore size coated on another layer of alumina having 30,000 nm pore size.

The nanostructured ceramic porous substrate may be formed of two or more layers, suitably a first layer comprising a conventional pressure-driven ceramic material, such as one or more of zeolite, titanium oxide, alumina, zirconia, etc., suitably with a second layer extending over at least a portion of the first layer, the second layer may be synthesized zeolite, titanium oxide, alumina, such as via hydrothermal crystallisation or dry gel conversion methods. Other nanostructured ceramic porous substrates may be reactive or catalyst coated ceramic surfaced substrates. Such substrates may advantageously lead to strong interaction with the active layer and improve the stability of the filters.

An inorganic-organic porous matrix substrate may be formed from inorganic particles contained within a porous organic polymeric substrate. An inorganic-organic porous matrix substrate may be formed from materials selected from zirconia nanoparticles with polysulfone (PSf) porous membrane. Advantageously, an inorganic-organic porous matrix substrate may provide a combination of an easy to manufacture low-cost substrate which has good mechanical strength. An inorganic-organic porous substrate, such as zirconia nanoparticles with polysulfone (PSf) may advantageously provide elevated permeability. Other inorganic-organic porous substrates may be selected from thin film nanocomposite substrates comprising one or more type of inorganic particle; metal-based foam (such as aluminium foam, copper foam, lead foam, zirconium foam, stannum foam, and gold foam); mixed matrix substrates comprising inorganic fillers in an organic matrix to form organic-inorganic mixed matrix.

The substrate may be manufactured as flat sheet stock, plates or as hollow fibres and then made into one of the several types of membrane substrates, such as hollow-fibre substrate, or spiral-wound membrane substrate. Suitable flat sheet substrates may be obtained from Dow Filmtec and GE Osmonics.

Advantageously, a substrate in the form of a porous polymeric substrate and metal, mesh can provide improved ease in processing and/or low cost.

The average pore/mesh size of the substrate may be ≥0.0001 μm, such as ≥0.001 μm, or ≥0.02 μm, or ≥0.1 μm.

The average pore/mesh size of the substrate may be ≤20 μm, such as ≤10 μm, or ≤5 μm, or ≤1 μm.

The average pore/mesh sizes of the substrate may be from 0.0001 μm to 20 μm, such as from 0.001 μm to 10 μm, or from 0.02 μm μm to 5; or from 0.1 to 1 μm.

The membrane of the present invention is suitable for a range of applications requiring different pressures. Advantageously, selection of the substrate pore size can be used to adjust the resultant membrane for improved performance under different pressure applications; such as smaller pore size for higher pressure application, and larger pore size for lower pressure applications. For example, a substrate may have an average pore size of ≤5 μm, such as ≤1 μm, or ≤0.5 μm, or ≤0.1 μm for applications with pressure ≥0.01 bar, ≥0.1 such as bar, ≥0.2 bar, ≥0.3 bar or ≤0.5 bar. Such selection of pore size based on the operational pressure has advantageously be found to maintain a water flux of ≥100 lmh/bar despite elevated pressure.

For example, a substrate for a pressure-assisted application, such as a PES substrate, may have a pore size of ≤1 μm at a pressure of ≥0.1 bar, such as ≤0.5 μm at a pressure of ≥0.5 bar, ≤0.3 μm at a pressure of ≥1 bar, or ≤0.2 μm at a pressure of ≥2 bar, or ≤0.1 μm at a pressure of ≥3 bar

The substrate layer may have any suitable thickness. The thickness of the substrate layer may be from 5 to 5000 μm, such as from 10 to 4500 μm, or from 50 to 4000 μm, or from 100 to 3700 μm, preferably from 150 to 3500 μm, more preferably from 180 to 3200 μm, such as from 220 to 3000 μm, or from 260 to 2700 μm, such as from 280 to 2400 μm. Optionally, the substrate layer may have a thickness of from 290 um to 2000 μm, such as from 295 to 1800 μm or from 300 to 1600 μm, preferably from 300 to 1400 μm. Suitably the substrate may be selected from a PET substrate, and/or a ceramic substrate. The PET membrane is preferred to be monofilament woven substrate, or a woven multifilament substrate.

The substrate may have a surface roughness, suitably Rz, of ≥20 nm, such as ≥50 nm or nm, such as ≥800 nm or ≥900 nm, such as ≥1050 nm, preferably ≥1100 nm. It has been found that increasing surface roughness can advantageously lead to better contact between the layers of the membrane for improved mechanical and structural integrity of layers. The increased roughness can also contribute to improved oleophobic or hydrophilic properties of the membrane.

The surface of the substrate operable to receive the active layer(s) may be hydrophilic. Suitably, the contact angle of water on the substrate surface is ≤65°, such as ≤60° and preferably ≤55°.

Advantageously, it has been found that a membrane comprising a hydrophilic substrate, such as hydrophilic polyvinylidene difluoride (PVDF), is able to withstand higher pressure in comparison to a hydrophobic substrate, such as unmodified PVDF.

The substrate may be a pre-treated substrate. The substrate may be treated prior to the addition of the coating formulations. For example, a surface of the substrate may have been subjected to hydrophilisation to form a hydrophilic surface. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. Preferably hydroxyl or carboxylic acid groups.

The grafting of functional groups may be achieved by plasma treatment, corona discharge, redox reaction, radiation, UV-ozone treatment, and/or chemical treatment. One example of plasma treatment is using an oxygen plasma on the substrate for thirty seconds.

An example of a treated substrate is grafted hydroxyl groups on a polyethersulfone substrate introduced by plasma treatment. The functionalised groups of the substrate may be operable to interact with a functional group of the adjacent coating layer, such as with physical and/or chemical bonding. For example, the said grafted hydroxyl groups may be operable to react with carboxylated hydrophilic cellulosic materials in an active layer via esterification or react with a siloxane component in an intermediate layer.

Additionally, or alternatively, surface treatment may be achieved by incorporating hydrophilic materials into the membrane substrate materials. As such, the substrate may comprise hydrophilic material.

The hydrophilic material that may be incorporated in to the substrate may be selected from cellulose acetate, quaternized polyethersulfone, polylactic acid, polyethylenimine, polyetherimide, polyvinylpyrrolidone and/or polyvinyl alcohol).

The hydrophilic material may be pre-blended into membrane substrate materials. The hydrophilic material may be incorporated using methods such as phase inversion, extrusion or interfacial polymerisation.

The substrate may comprise ≥1% hydrophilic material by weight of the substrate, such as ≥5 wt %, or ≥7 wt %. The substrate may comprise ≤50% hydrophilic material by weight of the substrate, such as ≤35 wt %, or ≥25 wt %. The substrate may comprise from 1 to 50% hydrophilic material by weight of the substrate, such as from 5 to 35 wt %, or from 7 to 25 wt %.

For example, a hydrophilic PES membrane substrate can be formed by adding an amount of PVP, such as 10 wt %, into a PES gel solution, and forming a substrate by phase inversion. A poly(ethersulfone) substrate incorporated with 10 wt % PVP has bone found to achieve better results in higher pressure applications in comparison to a hydrophobic PES substrate. For instance, a hydrophilic PES substrate modified with amount of PVP, such as 10 wt %, and having pore size of, for example, 0.1 um, may be selected for coating to form a membrane used under pressure applications, such as at least 1 bar; while a substrate with hydrophobic PES and, for example a 0.1 um spore size may be selected for coating to form a membrane more suitable for use under lower pressure, such as gravity driven, or less than 0.5 bar.

Advantageously, surface treatment of polymeric substrates may provide improved adhesion and uniformity of the subsequent coating layers applied on the substrate. The presence of said hydrophilicity and/or functionality on the polymeric substrate provides an active layer having a more robust mechanical integrity, a more uniform structure and improved continuity. The said hydrophilicity and/or functionality has also been found to provide improved filter life span and stability. Surface treatment can also improve properties such as enhanced permeability.

The hydrophilic agent may be a material having a surface tension that is lower than the surface energy of the substrate.

The hydrophilic agent, and/or active layer comprising the hydrophilic agent, may have a contact angle of ≤65°, such as ≤60°, or ≤55° such as ≤50°.

The hydrophilic agent, and/or active layer comprising the hydrophilic agent, suitably has a higher contact angle than the superhydrophilic agent, or the active layer comprising the superhydrophilic agent.

The hydrophilic agent or precursor thereof may be selected from a (co)polymer or oligomer, such as a polyelectrolyte, or polydopamine, or precursor thereof. A hydrophilic (co)polymer may be in the form of a hydrogel or be operable to form a hydrogel upon contact with water.

A hydrophilic agent (co)polymer may be formed from vinylpyrrolidone, vinyl alcohol, allylamine, ethylenimine, allylammonium chloride, vinylamine, lysine, chitosan, silane-based and/or its derivatives; acrylics, such as water soluble acrylics; acrylamide (e.g., copolymers containing 2-acrylamido-2-methylpropane sulfonic acid—AMPS); and/or hydroxyalkylmethacrylate, such as hydroxyethylmethacrylate (e.g. poly HEMA), and copolymers thereof, such as with acrylic acid, methacrylic acid, and/or 2-acrylamido-2-methylpropane sulfonic acid. The hydrophilic agent may be formed by template polymerisation, wherein monomers are polymerised in the presence of a polymer. Suitably, the hydrophilic polymer may be a copolymer formed from acrylamide and acrylic acid monomers with polyallylammonium chloride.

A hydrophilic (co)polymer formed from acrylamide and acrylic acid monomers with polyallylammonium chloride, may be formed from a mol ratio of acrylamide to acrylic acid monomers of ≥1:2, such as ≥1:1. For example, a mol ratio of acrylamide to acrylic acid monomers of up to ≤4:1, such as up to ≤3:1, or up to ≤2:1. For example, a mol ratio of acrylamide to acrylic add monomers of from 1:2 to 4:1, such as from 1:1 to 3:1, or from 1:1 to 2:1.

The hydrophilic agent may be in the form of a two-dimensional material and/or nanoparticle.

Advantageously, the presence of a hydrophilic two-dimensional material in combination with a superhydrophilic agent has been found to produce a membrane having improved separation performance and longer life span. The presence of the nanoparticles advantageously contributes to higher roughness of the surface and increases the specific surface contact area to the superhydrophilic layer.

The hydrophilic agent of the active layer or coating composition may comprise graphene-based materials, metal organic framework materials, silicene, germanene, stanene, boron-nitride, suitably h-boron nitride, carbon nitride, metal-organic nanosheets, molybdenum disulfide, tungsten disulfide, polymer/graphene aerogel, and/or positively charged polymers, preferably graphene-based materials.

The hydrophilic agent may comprise graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide, and/or polymer graphene aerogel. Preferably, the hydrophilic agent comprises graphene oxide. When used herein, ‘reduced graphene oxide’ means a form of graphene oxide that is treated by chemical, thermal or other methods in order to reduce the oxygen content.

The hydrophilic agent may have an average platelet size of from 1 nm to 100,000 nm, such as from 10 nm to 50,000 nm, or from 100 nm to 15,000 nm, preferably from 500 nm to 14,000 nm.

The hydrophilic agent may have a platelet size distribution D50 of from 1 nm to 15,000 nm, preferably from 100 nm to 14,000 nm. The graphene-based material may have a platelet size distribution D90 of from 5 nm to 15,000 nm, preferably from 100 nm to 14,000 nm.

The hydrophilic agent may have an oxygen atomic content of from 1% to 70%, such as from 5% to 60%, or from 10% to 50%, preferably from 15% to 55%.

Suitably, the hydrophilic agent, preferably graphene-based material such as graphene oxide, comprises hydroxyl, carboxylic and/or epoxide groups. The oxygen content of the hydrophilic agent, preferably with functional groups of hydroxyl and/or carboxylic groups, may be up to 60% oxygen atomic percentage, such as up to 50% or up to 45% oxygen atomic percentage. Suitably, the oxygen content is from 20 to 25% or from 25 to 45%. Advantageously, when the oxygen content is from 25 to 45% a surfactant may not be required to maintain stability of the coating composition. Preferably, the oxygen content is from 25 to 40% oxygen atomic percentage. Such a range can provide improved stability of the coating composition despite the absence of other stabilising components such as surfactants, and provide enhanced interaction with a primer layer. Oxygen content may be characterised by X-ray photoelectron spectroscopy (XPS), K-Alpha grade, from ThermoFisher Scientific.

The hydrophilic agent, suitably graphene-based material such as graphene oxide, may be optionally grafted with further functional groups. The optional functional groups may be grafted functional groups, and preferably grafted via reaction with the existing hydroxyl, carboxylic and epoxide groups of the hydrophilic agent. Functionalisation includes covalent modification and non-covalent modification. Covalent modification method can be subcategorised to nucleophilic substitution reaction, electrophilic substitution reaction, condensation reaction, and addition reaction. Examples of optional functional groups are amine groups; aliphatic amine groups, such as long-chain (e.g., C18 to C50) aliphatic amine groups; porphyrin-functionalised secondary amine groups, and/or 3-amino-propyltriethoxysilane groups. The hydrophilic agent may comprise amino groups, suitably grafted amino groups, and preferably grafted to the hydrophilic agent.

The size distribution of the hydrophilic agent may be such that at least 30 wt % of the material have a diameter of between 1 nm to 5,000 nm, such as between 1 to 750 nm, 100 to 500 nm, 100 to 400 nm, 500 to 1000 nm, 1000 to 3000 nm, 1000 to 5000 nm, 1500 to 2500 nm, or 500 to 1500 nm, preferably 100 to 3000 nm, more preferably at least 40 wt %, 50 wt %, 60 wt %, 70 wt % and most preferably at least 80 wt % or at least 90 wt % or 95 wt % or 98 wt % or 99 wt %. The size of the hydrophilic agent and size distribution may be measured using transmission electron microscopy (TEM, JEM-2100F, JEOL Ltd. Japan).

The hydrophilic agent may be in the form of a monolayer or multi-layered particle, preferably a monolayer. The particles of hydrophilic agent may be formed of single, two or few layers of hydrophilic agent, wherein few may be defined as between 3 and 20 layers. Suitably, the hydrophilic agent may comprise from 1 to 15 layers, such as from 2 to 10 layers or 5 to 15 layers. Suitably, at least 30 wt % of the hydrophilic agent comprise from 1 to 15 layers, such as from 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the hydrophilic agent may be measured using atomic force microscopy (AFM or transmission electron microscopy (TEM)) (TT-AFM, AFM workshop Co., CA, USA).

The water contact angle of the superhydrophilic agent, the active layer, or coating composition, suitably the water contact angle of the active layer comprising the superhydrophilic agent, may be ≤25°, such as ≤20°, such as ≤15°, preferably ≤10°. When used herein, the water contact angle was measured according to ASTM D7334-08.

The superhydrophilic agent may be selected from a (co)polymer or oligomer, such as a polymer electrolyte, or precursor thereof.

The superhydrophilic (co)polymer or precursor thereof may be selected from a polyelectrolyte, a polymer salt, and/or an ionised polymer, or precursor thereof. A superhydrophilic (co)polymer may be in the form of a hydrogel, or be operable to form a hydrogel upon contact with water.

A superhydrophilic (co)polymer salt may be selected from a cationic alkali metal salt, an alkali earth metal salt, a d-block metal salt, a p-block metal salt and/or a rare earth metal salt, suitably an alkali metal salt or an alkali earth metal salt, typically an alkali metal salt, such as a sodium or potassium salt. For example, a superhydrophilic (co)polymer salt may be polyacrylate sodium, carboxylic methyl cellulosic sodium and/or poly(sodium styrene sulfonate).

A superhydrophilic ionised (co)polymer may be a polymer that is at least partially ionised, for example such that at least a portion of the polymer has been protonated, deprotonated or metallated, such as lithiated, sodiated etc. For example, a superhydrophilic (co)polymer ionised (co)polymer may be polyacrylic acid, polypeptide, DNA, nucleic acid, poly(phosphoric acid), poly(vinylamine), bis(triflouoromethane)sulfonimide lithium, polyethylene glycol) (PEG) complexed with alkali metal salt, such as PEG-Li complex organic salt, and/or polystyrene-block-PEG deblock complexed with sodium.

The superhydrophilic agent (co)polymer may be formed from monomers including a vinyl monomer, such as styrene sulfonate salt, vinyl ether (such as methyl vinyl ether), N-vinyl-2-pyrrolidone (NVP), vinyl acetate (VAc); a silane-based monomer and/or its derivatives; an acrylic monomer, such as a (hetero)aliphatic (alk)acrylate, acrylic acids and salts thereof, bisphenol acrylics, fluorinated acrylate, methacrylate, polyfunctional acrylate, hydroxyethoxyethyl methacrylate (HEEMA), hydroxydiethoxyethylmethacrylate (HDEEMA), methoxyethyl methacrylate (MEMA), methoxyethoxyethyl meth acrylate (MEEMA), methoxydiethoxyethyl methacrylate (MDEEMA), ethylene glycol dimethacrylate (EGDMA), acrylic acid (AA), PEG acrylate (PEGA), PEG methacrylate (PEGMA), PEG diacrylate (PEGDA), PEG dimethacrylate (PEGDMA), bis(trimethylsilyloxy)methylsilylpropyl glycerol methacrylate (SiMA), methacryloyloxyethyl phosphorylcholine (MPC), 6-acetyithiohexyl methacrylate, acrylic anhydride, [2-(acryloyloxy)ethyl]trimethylammoniurn chloride, 2-(4-benzoyl-3-hydroxyphenoxy)ethyl acrylate, benzyl acrylate, or their trimethacrylate, dimethacrylate tri-block derivatives; thiol functionalised acrylate monomers, such as thiol functionalised (meth)acrylate; acryloyl chloride; acrylonitrile; maleimide; an acrylamide based monomer, such as acrylamide, methacrylarnide; N,N-dimethylacrylamide (DMA), 2-acrylamido-2-methylpropane sulfonic acid, N-isopropyl AAm (NIPAAm), N-(2-hydroxypropyl) methacrylamide (HPMA), 4-acryloylmorpholine; carbohydrate monomer; a polyacid and/or polyol, such as maleic acid (such as maleic acid with a vinyl ether (e.g., Gantrez, partially neutralised with sodium)), ethylene glycol (EG); gelatin methacryloyl; and/or methacrylated hyaluronic acid, optionally with crosslinkers such as epichlorohydrin (ECH), NN′-methylene-bis-acrylamide (BIS) and/or divinyl sulfone (DVS).

A superhydrophilic agent (co)polymer may have a molecular weight (Mw) of ≥2,000 g/mol, such as ≥4,000 g/mol, or ≥6,000 g/mol. For example, up to ≥30,000 g/mol, such as up to ≤20,000 g/mol, or up to ≤15,000 g/mol. For example, from 2,000 to 30,000 g/mol, such as from 4,000 to 20,000 g/mol, or from 6,000 to 15,000 g/mol.

The superhydrophilic agent, hydrophilic agent when present, or precursors thereof, active layer and/or film former, when present, may be at least partially crosslinked, or be operable to be at least partially crosslinked. The hydrophilic agent, superhydrophilic agent, or precursors thereof, film former and/or active layer may be at least partially crosslinked by using an additive crosslinker. As such, the coating composition comprising the hydrophilic agent, superhydrophilic agent and/or film former may further comprise an additive crosslinker. The hydrophilic agent, superhydrophilic agent, or precursors thereof, active layer and/or film former, may be at least partially self-crosslinked, or be operable to be self-crosslinked prior.

The crosslinking may be covalent, ionic and/or due to physical interactions or combination, suitably covalently crosslinked.

The hydrophilic agent, when present, or active layer comprising the said agent, may be substantially non-crosslinked.

The hydrophilic, superhydrophilic (co)polymer, or precursors thereof, and/or film former (co)polymer, when present, may be formed from a crosslinker or residue thereof, suitably in an amount of ≥0.5% by weight of the total monomers of the (co)polymer, or ≥0.8 wt % or ≥1 wt %. For example, up to ≤15% by weight of the total monomers of the (co)polymer, up to ≤10 wt % or up to ≤5 wt %. For example, from 0.5 to 15% by weight of the total monomers of the (co)polymer, or from 0.8 to 10 wt % or from 1 to 5 wt %.

The coating composition may comprise a crosslinker in an amount of ≥0.5% by dry weight the composition, such as ≥0.8 wt % or ≥1 wt %. For example, up to ≤15% by dry weight the composition, such as up to ≤10 wt % or up to ≤5 wt %. For example, from 0.5 to 15% by by dry weight the composition, such as from 0.8 to 10 wt % or from 1 to 5 wt %.

The crosslinker may be a multi-functional component, such as a multi-functional acrylic or vinyl monomer, a divalent metal ion, multi-functional carbodiimide, multi-functional aziridine, silane; multi-functional epoxide andlor multi-functional isocyanate.

The coating composition may comprise a pre-crosslinked water or alkaline swellable polymer, for example, copolymers of acrylic acid, methacrylic acid and acrylamide (AMPS) (Rheothix™ 601).

The crosslinker may be selected from tetramethylethylenediamine, methylene bis-acrylamide, ethylene glycol dimethacrylate, polyethylene glycol dimenthacrylate, triethylene glycol dimethacrylate N-isopropylacrylamide; N,N-diethylacylamide, epichlorohydrin (ECH), N,N′-methylene-bis-acrylamide (BIS), divinyl sulfone (DVS), citric acid, dicysteine peptides, dithiothreitol (DTT), glutaraldehyde; enzymatic crosslinking, such as transglutaminase, and a combination of horseradish peroxidese (HRP) and hydrogen peroxide, or a residue thereof.

The hydrophilic agent, superhydrophilic agent, or precursors thereof, and/or film former when present, may comprise a functional group that is operable to be crosslinked, or residue thereof. For example, the hydrophilic agent, superhydrophilic agent, or precursors thereof, and/or film former when present, may comprise acid functionality, such as carboxylic acid functionality, or residues thereof. In the active layer, the crosslinking density may be at least 2 molar % of the crosslinkable functional groups, such as at least 5 molar % or at least 10 molar %.

As used herein, the crosslinking density was measured by the following method. The polymer was swelled in a solvent until equilibrium. The swollen gel was then isolated and weighed. The weights of swelling solvent and polymer were determined after removing the solvent by vacuum-drying. The following equation was then applied:

Crosslink density, network chain per gram=[In(1−Vp)+(Vp)+X(Vp)\hat{ }2]/(Dp(Vo)[(Vr))\hat{ }(1/3)−(Vp)/2])

where
Vp=Volume fraction of polymer in the swollen polymer
X=Huggins polymer-solvent interaction constant
Dp=Density of polymer (g/cm)\hat{ }3)
Vo=Molar volume of solvent (cm)\hat{ }3/mol)
Do=Density of solvent (g/cm)\hat{ }3)

### Here,

Vp=1/(1+Q),

Where Q is the ratio of the weight of solvent in swollen polymer (XDp) and the weight of polymer (XDo).

The hydrophilic agent, superhydrophilic agent, and/or active layer may be crosslinked, or be operable to be crosslinked, using a radiation source and/or heat, such as UV-vis light, infrared, optionally in the presence of an initiator, such as a photo-initiator. As such, the coating composition comprising the hydrophilic agent and/or superhydrophilic agent may further comprise an initiator. For example, the superhydrophilic agent may be crosslinked gelatin methacryloyl, also referred as gelatin methacrylate, or methacrylate gelatin; or crosslinked methacrylated hyaluronic acid, wherein the gelatin methacryloyl or methacrylated hyaluronic acid may be crosslinked with the assistance of a photo initiator under UV light exposure.

Polyelectrolyte as used herein in relation to the hydrophilic and superhydrophilic agents refers to a polymer that has ionizable groups. The polyelectrolyte may be cationic, anionic, and/or nonionic according to the nature of the functional groups along the polymer chain. A polyelectrolyte may be selected from poly(diallyldimethylammonium chloride), poly(acylic acid), nucleic acid, poly(phosphoric acid), poly(methacrylic acid), poly(vinylamine), poly(ethylenesulfonic acid), poly(4-vinyl-N-alkylpyridinium chloride), poly(ethyleneimine), poly(itaconic acid), poly(acrylic acid) salt such as sodium or magnesium salt, poly(2-vinyl-1-methylpyridinium bromide or chloride), polystyrene sulphonate (e.g. sodium salts), polyvinylimidazole (PVI), polydiallyldimethylammonium, polyethylene oxide, acrylamide and/or ethylene glycol copolymers with quaternary ammonium salts, such as partially or fully neutralised with alkali metal salts, e.g., and/or copolymers thereof, poly (methacrylic acid) (e.g. sodium salts) and/or copolymers thereof, e.g., copolymers of (methacrylic acid) and acrylamide, such as produced by inverse emulsion polymerisation, poly(itaconic acid); including salts thereof, such as sodium, potassium, lithium and/or ammonium salt and/or copolymers thereof. Suitably a superhydrophilic polyelectrolyte may be an acrylic (co)polymer formed from (meth)acrylic acid, wherein at least part of the acrylic acid is in the form of a suitable salt, such as a sodium, potassium, lithium and/or ammonium salt, suitably a sodium salt; and/or a (co)polymer formed from styrene sulfonate acid, wherein at least part of the acid is in the form of a suitable salt such as a sodium, potassium, lithium and/or ammonium salt, suitably a sodium salt.

A polyelectrolyte copolymer may be selected from poly(styrene-alt-maleic acid) sodium, chitosan-g-poly(acrylic acid) copolymer sodium, 2-propenoic acid, 2-methyl, polymer with sodium and/or 2-methyl-2((1-oxo-2-propen-1-yl)amino)-1-propanesulfonate.

Hydrogel when used herein in relation to the hydrophilic agent and the superhydrophilic agent may mean an insoluble polymeric network characterized by the presence of physical and/or chemical crosslinking among the polymer chains and the presence of water, suitably in a non-insignificant amount, such as in an amount of at least 10% of the total weight of the polymer composition. The hydrophilic agent and/or the superhydrophilic agent may be in the form of a dehydrated hydrogel that is operable to form a hydrated hydrogel upon contact with water.

A hydrogel may be selected from conventional hydrogels, smart hydrogels (such as pH sensitive, temperature sensitive, pressure sensitive, light sensitive, etc), bio-hydrogels, semi-interpenetrating network hydrogel, interpenetrating network hydrogels, self-assembling peptide system hydrogels, amorphous hydrogels, semi-crystalline hydrogels, crystalline hydrogels and other hydrogels.

Conventional hydrogels may be selected from poly(2-hydroxyethyl methacrylate) (PHEMA) crosslinked by polyethylene glycol dimethacrylate, for example via UV light using sensitive initiator such as benzoin isobutyl ether; 2-hydroxyethyl methacrylate (HEMA) derivatives; hydroxyethoxyethyl methacrylate (HEEMA) crosslinked by polyethylene glycol dimethacrylate and/or triethylene glycol dimethacrylate (TEGDMA), for example via UV light using photoinitiator; polyethylene glycol (PEG) crosslinked by triethylene glycol dimethacrylate (TEGDMA), for example via UV light using sensitive initiator; methacrylic acid (MAA) and poly(ethylene glycol) -poly(ethylene glycol) methacrylate (PEG-PEGMA); carboxymethyl cellulose (CMC) sodium; and/or polyvinylpyrrolidone (PVP) hydrogels crosslinked by tetra(ethylene glycol) dimethacrylate, for example via free radical polymerisation.

Semi-interpenetration (IPN) network hydrogels may be selected from acrylamide/acrylic acid copolymer; linear cationic polyallylammonium chloride; copolymer of N-isopropylacrylamide (NIPAAm) with poly(ethylene glycol)-co-poly(E-caprolactone) (PEG-co-PCL), crosslinked by N, N′-methylene bisacrylamide and/or sodium alginate, for example, by using template copolymerisation, or UV light or crosslinked by N,N,N′,N′-tetramethylethylenediamine (TEMED) and/or ammonium persulphate (APS) with UV light, such as alginate and alginate derivatives; amphiphilic alginate crosslinked by ions, or covalently crosslinked with polyethylene glycol diamines, suitably with a with different Mw, or crosslinked by methacrylateplus eosin and triethanol amine, for example using argon ion laser at 514 nm wavelength.

Self-assembling peptide system hydrogels may be selected from acrylate-modified PEG and acrylate-modified hyaluronic acid; heparin and amine end-functionalised 4 arm star-PEG, for example crosslinked via UV light with photo-initiator and/or crosslinked in solutions of 1-ethyl (3-dimethylaminopropyl) carbodlimide (EDC) alone, and/or in combination with N-hydroxysuccinimide (NHS) or sulfo-NHS solutions.

Temperature sensitive hydrogels may be selected from poly(N-isopropylacrylamide) (PNIAAm), poly(N,N-diethylacylamide) (PDEAAm), copolymer (poly(N-isopropylacrylamide-co-butyl acrylate) (P(NIAAm-co-BA)), poly(organophosphazene) thermogels.

The pH sensitive hydrogels may be selected from poly(acrylic acid), poly(N,N′-diethylaminoethyl methacrylate) ionisation, poly(acrylamide) (PAAm), poly(methacrylic acid) (PMAA), poly(diethylaminoethyl methacrylate) (PDEAEMA), and/or poly(dimethylaminoethyl methacrylate) (PDMAEMA).

Other hydrogels may include electro-sensitive hydrogels; epichlorohydrin (ECH); N,N′-methylene-bis-acrylamide (BIS); divinyl sulfone (DVS); poly(2-oxazoline); maleic anhydride copolymers; dihydroxy; protein based hydrogels, such as elastin, gelatin, fibrin, silk fibroin; polysaccharide based hydrogels, such as starch, cellulose, chitosan, alginic acid, agar, xylan, glucan, carrageenan, pectin, gum arabic, guar gum, curdlan gum, gellan gum, xanthan gum, locust bean gum hydrogels; zwitterionic based hydrogels, such as sulfobetaine methacrylate (SBMA), sulfobetaine acrylamide, sulfobetaine methacrylamide, carboxybetaine methacrylate (CBMA), carboxybetaine acrylamide and carboxybetaine methacrylamide; poly-sulfobetaine methacrylate (pSBMA), poly(carboxy betaine methacrylate) (polyCBMA), poly(carboxybetaine acrylamide), poly(carboxybetaine methacrylamide), poly(sulfobetaine acrylamide), and poly(sulfobetaine methacrylamide); silicone hydrogels; siloxymethacrylate (TRIS) based hydrogels; silicone co-polymer based hydrogels, such as copolymer of 3-(methacryloyloxy)propyltris(trimethylsiloxy)silane, N,N-dimethylacrylamide, 3-(methacryloyloxy)propyltris(trimethylsiloxy)silane 1-vinyl-2-pyrrolidinone, and 2-hydroxyethylmethacrylate (TRIS-DMA-NVP-HEMA copolymer hydrogel). 3-(methacryloyloxy)propyltris(trimethylsiloxy)silane, N,N-dimethylacrylamide, 1-vinyl-2-pyrrolidinone (TRIS-DMA-NVP copolymer hydrogel); polydimethylsiloxane (PDMS) hydrogel or polydimethylsiloxane copolymer hydrogel; vinyl pyrrolidone/acrylic acid/lauryl methacrylate terpolymer, and/or acrylic acid/vinylpyrrolidone crosspolymer.

Suitably, a superhydrophilic (co)polymer hydrogel may be selected from: carboxymethyl cellulose (CMC), and/or polyvinylpyrrolidone (PVP) hydrogel, crosslinked for example by tetra(ethylene glycol) dimethacrylate, such as via free radical polymerisation, suitably wherein at least part of the acid is in the form of a suitable salt, such as a carboxymethyl cellulose (CMC) sodium; N-isopropylacrylamide (NIPAAm) with polyethylene glycol)-co-poly(ε-caprolactone) (PEG-co-PCL), crosslinked for example by N,N′-methylene bisarrylamide and/or sodium alginate, for example by using template copolymerisation, or UV light or crosslinked by N,N,N′,N′-tetramethylethylenediamine (TEMED) and/or ammonium persulphate (APS) with UV light, such as alginate and alginate derivatives; 3-(methacryloyloxy)propyltris(trimethylsiloxy)silane, N,N-dimethylacrylamide, 3-(methacryloyloxy)propyltris(trimethylsiloxy)silarie 1-vinyl-2-pyrrolidinone, and/or 2-hydroxyethylmethacrylate (TRIS-DMA-NVP-HEMA copolymer hydrogel).

Advantageously, it has been found that the use of a hydrogel can provide improved separation while also improving the mechanical stability of the membrane.

The “term” precursor when used herein in relation to the hydrophilic and superhydrophilic agents refers to a compound that is operable to form the hydrophilic or superhydrophilic agent using methods known to the skilled person. For example, the precursor may be an oligomer, or pre-crosslinked polymer which form the hydrophilic or superhydrophilic agent after chemical or physical crosslinking, such as with UV-light with photo-initialiser, heat treatment, etc. For example, a precursor may comprise a mixture of acrylamide and acrylic acid monomers with poly(allylamonium chloride), and with 2,2 -Azobis(2-methylpropionamidine) dihydrochloride (AIBA) as initiator, and N,N′-methylene bisacrylamide (MBAM) as crosslinker. This mixture may be considered to be a hydrophilic agent precursor as it is operable to form a hydrophilic agent in the active layer via template polymerisation. Another example of a suitable precursor includes polyethylene glycol (PEG) mixed with triethylene glycol dimethacrylate (TEGDMA), which is operable to form the hydrophilic agent in the active layer via UV light with a photo-initiator.

The active layer or coating composition may further comprise nano/micro sized particles. The presence of such particles can advantageously increase the roughness of the surface. The particles may comprise silica; fumed silica; titanium oxide, polystyrene nanobeads; and/or nano/micro clays such as montmorillonite, bentonite, kaolinite, hectorite and/or halloysite. The particles may have an average diameter of from 1 nm to 10,000 nm, such as from 2 nm to 5,000 nm, preferably from 5 nm to 500 nm.

Controlled size nanoparticles may be formed from precursors by sol-gel method, hydrothermal method, solvothermal methods, or surfactant-assisted method. Such as using TiCl₄ as precursor in the presence of HCl, Na₂SO₄.

Optionally the active layer or coating formulation may comprise a film former, such as a linear and/or hydrophilic polymer (e.g. PVP etc), The film former may be covalently linked, or be operable to form a covalent link, with the superhydrophilic agent and/or form an interpenetrating network with the superhydrophilic agent. The use of a film former has been found to improve the robustness and integrity of the active layer and coherent of the active layers. A film former may be selected from a water-soluble film former, solvent based film former, pseudo-latex dispersion based film former, and/or pharmaceutical relevant film former. A film former may be selected from a polysaccharide or derivative thereof, such as cellulose or a derivative thereof, for example methylcellulose, hydroxyethyl cellulose, hydroxypropyl cellulose, hydroxypropyl methylcellulose, cellulose acetate phthalate, hydroxypropyl methylcellulose phthalate, carboxymethyl ethylcellulose, hydroxypropyl methylcellulose acetate succinate, ethylcellulose, sodium alginate; acrylic (co)polymers; vinyl (co)polymer, such as polyvinyl pyrrolidone; polyvinyl alcohol, polyvinyl acetate phthalate; polyethylene glycol, polyethyleneimine (PEI); and/or poly(ethylene) oxide. Preferably, the film former is a water-soluble film former, such as hydroxypropyl methylcellulose acetate succinate. It will be apparent that a film former may also be a superhydrophilic agent according to the present invention.

The amount of film former in the coating composition may be ≤10 wt % by dry weight of the coating composition, such as ≤5 wt %, such as ≤4 wt %, ≤3.5 wt %, ≤3 wt %, ≤2.5 wt %, preferably ≤2 wt %.

The selection of the photo-initiator may be based on the absorption bands of the photo-initiator which must overlap with the emission spectrum of the radiation source and there should be minimal competing absorption by the components of the formulation at the wavelengths corresponding to photo-initiator excitation. The photo-initiator may be a radical or cationic photo-initiator.

The photo-initiator may be selected from acetophenone, anisoin, anthraquinone, anthraquinone-2-sulfonic acid, sodium salt monohydrate, (benzene) tricarbonylchromium, benzil, benzoin, benzoin ethyl ether, benzoin isobutyl ether, benzoin methyl ether, benzophenone, benzophenone/1-hydroxycyclohexyl phenyl ketone, 3,3′,4,4′-benzophenonetetracarboxylic dianhydride, benzoylbiphenyl, 2-benzyl-2-(dimethylamino)-4′-morpholinobutyrophenone, 4,4′-bis(diethylamino)benzophenone, 4,4′-bis(dimethylamino)benzaphenone, camphorquinone, 2-chlorothioxanthen-9-one, (cumene)cyclopentadienyliron(ii) hexafluorophosphate, dibenzosuberenone, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 2,5-dimethylbenzaphenone, 3,4-dimethylbenzophenone, diphenyl(2,4,6-trimethylbenzoyl)phosphine oxide/2-hydroxy-2-methylpropiaphenone, 50/50 blend, 4′-ethoxyacetophenone, 2-ethylanthraguinone, f40-8 ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-rnethylbenzophenone, methybenzoylformate, 2-methyl-4′-(methylthio)-2-morpholinopropiophenone, phenanthrenequinone, 4′-phenoxyacetophenone, thioxanthen-9-one, triarylsulfonium hexafluoroantimonate salts, such as mixed, 50% in propylene carbonate, triarylsulfonium hexafluorophosphate salts, such as mixed, 50% in propylene carbonate, such as in-organic photo-initiator, such as titanium dioxide (TiO₂).

A photo-initiator may be selected from anisoin, anthraquinone, anthraquinone-2-sulfonic acid, sodium salt monohydrate, (benzene) tricarbonylchromium, benzil, benzoin, benzoin ethyl ether, benzoin isobutyl ether, benzoin methyl ether, benzophenone, and/or benzophenonel hydroxycyclohexyl phenyl ketone.

Optionally, the active layer or coating composition may comprise other additives, such as wetting agents, adhesion promoters, cosolvents, and/or rheology modifiers. Additives may be selected from one or more of lactose, cellulosic oligomers, such as sodium cellulosic oligomer, cellulose ethers, nanofillers, surface modifying macromolecules and zvvitterions. The additive may be a hydrophilic additives, which can further improve the surface robustness of the coating. Commercial grades of sodium cellulosic oligomer and cellulose ethers could be obtained commercially from Dupont under commercial names of Walocel™, and Methocel™. The addition of such additives could potentially improve the film quality, such as robustness, film finish of the active layer.

The coating composition may be a liquid composition. When formulated as a liquid composition for use in the present invention, e.g. as a solution, dispersion or suspension, a suitable carrier liquid or solvent may be aqueous or organic, and other components will be chosen accordingly.

For example, the liquid carrier may comprise water and/or an organic solvent such as acetone, methanol, ethanol, propanol, ethylene glycol, propylene glycol, dipropylene glycol, dimethoxy ether of dipropylene glycol, methoxy ethyl acetate, isopropanol; tetrahydrofuran (THF), N,N-dimethylformamide (DMF), N-methyl-2-pyrrolidone (NMP), toluene, xylene, methyl ethyl ketone, and/or ethyl acetate, optionally with other materials to enhance performance and/or rheology of the composition including any one or more of binders, drying additives, antioxidants, reducing agents, lubricating agents, plasticisers, waxes, chelating agents, surfactants, pigments, defoamers, biocides, and initiators.

The liquid carrier, suitably for the hydrophilic agent such as a graphene-based material, may be selected from water, acetone, methanol, ethanol, propanol, iso-propanol, ethylene glycol, propylene glycol, tetrahydrofuran (THF), N,N-dimethylformamide (DMF), N-methyl-2-pyrrolidone (NMP), ethyl acetate, toluene, and/or xylene, or mixtures thereof. The liquid carrier may comprise water with one or more surfactants, or N-methyl-2-pyrrolidone (NMP). Preferably, the liquid carrier is selected from water or ethanol, or from a 1 to 99% by volume of of a water/ethanol mixture.

The coating composition may comprise the hydrophilic agent in an amount of up to 0.5% by total weight of the coating composition, such as up to 0.45 wt % or up to 0.4 wt %, or preferably up to 0.35 wt %, preferably up to 0.3 wt %.

The coating composition may comprise the hydrophilic agent in an amount of at least 0.01% by total weight of the coating composition, such as at least 0.02 wt % or at least 0.025 wt %, or preferably at least 0.03 wt %, more preferably at least 0.05 wt %.

The coating composition may comprise the hydrophilic agent in an amount of from 0.01% to 0.5% by total weight of the coating composition, such as from 0.02 wt % to 0.45 wt % or from 0.025 wt % to 0.4 wt %, or preferably from 0.03 wt % to 0.35 wt %, preferably from 0.05 to 0.3 wt %.

The coating composition may comprise the superhydrophilic agent in an amount of up to 99 wt % by total weight of the composition, such as up to 80 wt %, up to 50 wt %, preferably up to 30 wt %.

The coating composition may comprise the superhydrophilic agent in an amount of at least 0.01 wt % by total weight of the composition, such as at least 0.02 wt %, or at least 0.05 wt %, preferably at least 0.1 wt %.

The coating composition may comprise the superhydrophilic agent in an amount of from 0.01 wt % to 99 wt % by total weight of the composition, such as 0.02 wt % to 80 wt %, 0.05 wt % to 50 wt %, preferably from 0.1 wt % to 30 wt %.

The coating composition may comprise nano/micro particles in an amount of from 0.1 wt % to 10 wt %, such as from 0.5 wt % to 5 wt %, suitably from 0.75 wt % to 3 wt %.

The active layer coating composition, such as the first and/or second active layer coating composition may have a solid content of up to 90 wt %, such as up to 80 wt %, or up to 70 wt %, such as up to 60 wt %, preferably up to 50 wt %, such up to 30 wt %.

The active layer and/or coating composition for forming the active layer may comprise a superhydrophilic agent; optionally an initiator or residue thereof, such as a photo-initiator; and a film former, wherein the composition is crosslinked or is operable to crosslinked, optionally comprising a crosslinker. It has been found that crosslinked active layer comprising film former provides improved robustness and integration in the active layer.

An active layer coating formulation may comprise a superhydrophilic agent; a film former, such as carboxymethyl cellulose (CMC) salt, and/or polyethylene glycol) (PEG); and a crosslinker, for example, citric acid. Such a composition may be coated onto a substrate and crosslinked by heat treatment, such as at ˜80° C. for 10 hours.

The superhydrophilic agent may be selected from poly(styrene sulphonate salt), such as the sodium salt, and/or or polyacrylic acid salt, such as sodium salt.

The substrate may be pre-treated, such as by coating, for example by dip coating, in dopamine, and heated treated, such as at 80° C. for 1 hour.

Such a coating has been found to produce a robust film on the membrane having good performance under elevated pressure.

The thickness of the active layer, suitably of the first active layer, may be at least 1 nm, such as at least 10 nm, or at least 20 nm; preferably at least 30 nm.

The thickness of the active layer, suitably of the first active layer, may be from 1 nm to 2000 nm, such as from 10 nm to 1500 nm, or from 20 nm to 1000 um; preferably from 30 nm to 800m. The thickness may be dependent on the concentration of the coating composition and number of coating layers.

The thickness of the active layer, suitably of the second active layer may be up to 100 um, such as up to 50 um, or up to 30 um; preferably up to 10 um.

The thickness of the active layer, suitably of the second active layer may be at least 100 nm, such as at least 250 nm, or at least 300 nm; preferably at least 400 nm.

The thickness of the active layer, suitably of the second active layer may be in a range of from 100 nm to 100 um, such as from 250 nm to 50 um, or from 300 nm to 30 um; preferably from 400 nm to 10 um.

The active layers may be applied by any suitable method. For example, the coating layers may be applied by a layer-by-layer (LBL) coating method. The layers may be applied by wire bar coating, roll-to-roll, spay and roller coating, curtain coating, slot die, inkjet printing, dip coating, vacuum deposition, or filtration coating.

Layer-by-layer coating methods may be assisted by thermal boost or reapplication of an intermediate layer with or without oxidation in between coating the layers.

Suitably, a curing process may be applied after the coating process, such as thermal curing, chemical curing, oxidisation curing, to facilitate integration of the active layers.

A thermal boost or cure may be used to facilitate the curing of the active layer, such as drying in an oven or air under various temperatures between different coating layers, such as at an average temperature of room temperature, or about 40° C., or about 60° C., such as about 80° C., preferably, below about 80° C., and for various times, such as for about 1 minute, such as for about 3 minutes, such as for about 10 minutes, such as for about 30 minutes, preferably shorter than 30 minutes. Such as about 75° C. for about 25 minutes.

The active layer may be subject to a crosslinking procedure after application of the coating composition to the substrate to form crosslinks between a film former, additive and/or the hydrophilic and/or superhydrophilic agent. The active layer may be subjected to light radiation, such as UV-light, laser, infrared, heat, pH change etc. to facilitate crosslinking.

The membrane may comprise an intermediate layer, suitably an intermediate layer as a primer layer arranged between the substrate and the active layer, an intermediate layer between the substrate and a first active layer, between adjacent first active layers in a series of first active layers, between a first active layer and a second active layer; and/or between adjacent second active layers in a series of second active layers.

The intermediate layer may enhance adhesion, mechanical integrity and/or coating uniformity of the subsequent active layers.

In particular, it has been found that it can be advantageous for the membrane to comprise an intermediate layer between the substrate and a first active layer, and/or between a first active layer and a second active layer. This can help to maintain the active layer by reducing dissolution of the layer or wearing out of the layer, thereby improving life expectancy.

The intermediate layer may be formed from a coating formulation, suitably a liquid coating composition, for example as defined above with respect to liquid coating composition of the active layer.

The intermediate layer or coating composition may comprise an adhesion promoter, oxidant, binder, epoxide, and/or crosslinker or residue thereof.

Adhesion promoters may form covalent bonds and/or strong physical attractions to the substrate and/or active layers. Suitably the adhesion promoter comprises a functional group that is operable to form chemical and/or physical bonds with the functional groups (e.g. hydroxyl and carboxylic) of the substrate and/or adjacent active layer. The adhesion promoter may be a waterborne adhesion promoter. The adhesion promoters may comprise silane or a derivative thereof, tannic acid, dopamine or a derivative thereof, and/or dopamine peptide; amine; diamine; methacrylate; epoxy; methyl, isobutyl, phenyl, octyl, or vinyl, chloroalkyl; vinylbenzylamino based adhesion promoter; organometallic such as organotitanate, organozirconate, organoaluminate; chlorinated or chlorine-free polyolefin; polyol based adhesion promoter (e.g., Evonik TEGO®) ViriPlus); polyester based adhesion promoter (e.g., Evonik TEGO® AddBond).

In a more preferred embodiment of the invention, the adhesion promoter may comprise a silane based adhesion promoter such as an acrylate and/or methacrylate functional silane, aldehyde functional silane, amino functional silane; such as amino alkoxysilane, anhydride functional silane, azide functional silane, carboxylate phosphonate and/or sulfonate functional silane, epoxy functional silane, ester functional silane, halogen functional silane, hydroxyl functional silane, isocyanate and/or masked isocyanate functional silane, phosphine and/or phosphate functional silane, sulfur functional silane, vinyl and/or olefin functional silane, multi-functional and/or polymeric silane, UV active and/or fluorescent silane, and/or chiral silane, trihydrosilane, etc.

The adhesion promoter may be selected from an amino functional silane, such as an amino alkoxysilane, suitably an aminoalkyl alkxoy silane.

The adhesion promoter may be selected from aminoethyl triethoxy silane, 2-aminoethyl trimethoxy silane, 2-aminoethyl triethoxy silane, 2-aminoethyl tripropoxy silane, 2-aminoethyl tributoxy silane, 1-aminoethyl trimethoxy silane, 1 -aminoethyl triethoxy silane, 3-aminopropyl trimethoxy silane, 3-aminopropyl triethoxy silane, 3-aminopropyl tripropoxy silane, 3-aminopropyl tributoxy silane, 3-aminopropyl ethyl dimethoxysilane, 3-a minopropyl aminopropyldieth ylethoxysilane ethyl diethoxysilane, 3-aminopropyl methyl dipropoxysilane, 3-aminopropyl ethyl dipropoxysilane, 3-aminopropyl propyl dipropoxysilane, 3-aminopropyl dimethyl methoxysilane, 3-aminopropyl dimethyl ethoxysilane, 3-aminopropyl diethyl ethoxysilane, 3-aminopropyl dimethyl propoxysilane, 3-aminopropyl diethyl propoxysilane, 3-aminopropyl dipropyl propoxysilane, 2-aminopropyl trimethoxy silane, 2-aminopropyl triethoxy silane, 2-aminopropyl tripropoxy silane, 2-aminopropyl tributoxy silane, 1-aminopropyl trimethoxy silane, 3-aminopropyl methyl dimethoxysilane, 1-aminopropyl triethoxy silane, 1-aminopropyl tripropoxy silane, 1-aminopropyl tributoxy silane, N-aminomethyl aminomethyl trimethoxy silane, N-aminomethyl aminomethyl tripropoxy silane, N-aminomethyl-2-aminoethyl trimethoxy silane, N-aminomethyl-2-aminoethyl triethoxy silane, N-aminomethyl-2-aminoethyl tripropoxy silane, N-aminomethyl-3-aminopropyl trimethoxy silane, N-aminomethyl-3-aminopropyl triethoxy silane, N-aminomethyl-3-aminopropyl tripropoxy silane, N-aminomethyl-2-aminopropyl trimethoxy silane, N-aminomethyl-2-aminopropyl triethoxy silane, N-aminomethyl-2-aminopropyl tripropoxy silane, N-aminopropyl trimethoxy silane, N-aminopropyl triethoxy silane, N-(2-aminoethyl)-2-aminoethyl trimethoxy silane, N-(2-aminoethyl)-2-aminoethyl triethoxy silane, N-(2-aminoethyl)-2-aminoethyl tripropoxy silane, N-(2-aminoethyl)-aminoethyl trimethoxy silane, N-(2-aminoethyl)-1-aminoethyl triethoxy silane, N-(2-aminoethyl)-1-aminoethyl tripropoxy silane, N-(2-aminoethyl)-3-aminopropyl triethoxy silane, N-(2-aminoethyl)-3-aminopropyl tripropoxy silane, N-(3-aminopropyl)-2-aminoethyl trimethoxy silane, N-(3-aminopropyl)-2-aminoethyl triethoxy silane, N-(3-aminopropyl)-2-aminoethyl tripropoxy silane, N-methyl-3-aminopropyl trimethoxy silane, 3-aminopropyl methyl dimethoxy silane, 3-aminopropyl methyl diethoxy silane, N-(2-aminoethyl)-3-aminopropyl methyl dimethoxy silane, 3-diethylene 3-diethylene triamine propyl triethoxy silane, 3-[2-(2-aminoethyl aminoethyl amino)propyl]trimethoxysilane, 3-[2-(2-aminoethyl aminoethyl amino) propyl] triethoxysilane, 3-[2-(2-aminoethyl aminoethyl amino) propyl] tripropoxysilane, and/or trimethoxy silyl propyl diethylene triamine.

The adhesion promoter may be selected from 3-aminopropyl trimethoxy silane.

The adhesion promoter may be present in the coating composition in an amount of up to 99% based on the total weight of the composition, such as up to 80 wt %, or up to 50 wt %, preferably up to 30 wt %.

The adhesion promoter may be present in the coating composition in an amount of at least 0.01% based on the total weight of the composition, such as at least 0.02 wt %, or at least 0.05 wt %, preferably at least 0.1 wt %.

The adhesion promoter may be present in the coating composition in an amount of from 0.01% to 99% based on the total weight of the composition, such as from 0.02 wt % to 80 wt %, from 0.05 wt % to 50 wt %, preferably from 0.1 wt % to 30 wt %.

An oxidant may be used in the intermediate layer to facilitate the curing of the adhesion promoter and the intermediate layer such as sodium periodate (NaIO₄), ammonium per(oxodi)sulfate ((NH₄)₂S₂O₈), potassium permanganate (KMnO₄), copper sulfate (CuSO₄), and/or Fe(III).

The oxidant may be present in the coating composition in an amount of up to 200 wt % by weight of the adhesion promoter, such as ≤150 wt %, ≤120 wt %, or ≤110 wt %, preferably ≤100 wt %.

The adhesion promoter and oxidant may be in the same intermediate layer composition and/or layer or be applied separately. Suitably the oxidant may be in a separate intermediate layer coating composition and/or layer, and may be applied after the adhesion promoter intermediate layer composition.

Suitably one or more oxidants are used to facilitate the curing of the intermediate layer, and they may be added into the intermediate layer composition concentration of up to 100% by weight solid of the composition, such as from 0.01 wt % to 99 wt % in water, such as 0.02 wt % to 80 wt %, 0.05 wt % to 50 wt %, preferably from 0.1 wt % to 30 wt %.

Optionally the intermediate layer or intermediate layer coating composition may comprise further components such as a film former, crosslinker, initiator or further additive as defined above for the active layer coating composition.

The intermediate layer coating composition may have solid content of up to 90% by total weight of the composition, such as up to 80 wt %, or up to 70 wt %, such as up to 60 wt %, preferably up to 50 wt %, such up to 30 wt %.

A method to apply the intermediate layer composition may be by sequential layer by layer coating. This can practically be achieved by wire bar coating, roll-to-roll, spay and roller coating, curtain coating, slot die, inkjet printing, dip coating, vacuum deposition, filtration coating, preferably dip coating.

A temperature cure stage may be used to facilitate the curing of the intermediate layer, such as from about 30° C. to 200° C., or from about 35° C. to 150° C., preferably from about 40° C. to 80° C., and/or with curing time of from 1 to 1000 minutes, such as from 2 to 500 minutes, preferably from 3 to 60 minutes.

The membrane may be operable to function at elevated pressure. For example, the membrane may be operable to function at a pressure of ≤0.01 bar, such as ≤0.1 bar, ≤0.5 bar, or ≤1 bar.

The membrane may be operable to function at various temperatures, such ≤100° C., such ≤90° C., such as ≤80° C., preferably from 0° C. to 80° C.

The membrane may be operable to be arranged into a drainage device, suitably fixedly arranged, such as in fuel tanks, such as drain valves in fuel tanks.

The drainage device may be for an automotive product, such as a marine or aviation fuel storage tank.

An automotive product may be a vehicle or any part thereof. The term “vehicle” is used in its broadest sense and includes (without limitation) all types of aircraft, spacecraft, watercraft, and ground vehicles. For example, a vehicle can include, aircraft such as airplanes including private aircraft, and small, medium, or large commercial passenger, freight, and military aircraft; helicopters, including private, commercial, and military helicopters; aerospace vehicles including, rockets and other spacecraft. Vehicles can include ground vehicles such as, for example, trailers, cars, trucks, buses, coaches, vans, ambulances, fire engines, motorhomes, caravans, go-karts, buggies, fork-lift trucks, sit-on lawnmowers, agricultural vehicles such as, for example, tractors and harvesters, construction vehicles such as, for example, diggers, bulldozers and cranes, golf carts, motorcycles, bicycles, trains, and railroad cars. Vehicles can also include watercraft such as, for example, ships, submarines, boats, jet-skis and hovercraft. Parts of vehicles may include vehicular body parts, hulls, marine superstructures, vehicular frames, chassis, and vehicular parts not normally visible in use, such as engine parts and fuel tanks.

The membrane, device or fuel tank may be applied for oil and water separation, oil emulsion in water separation, hydrocarbon/water separation, produced water separation, water filtration, contaminated fuel treatment. Preferably contaminated fuel treatment, such as kerosene/water separation, diesel/water separation, petrol/water separation, engine oil/water separation.

The membrane may be operable to separate low water content oil and water mixtures. For example, the membrane may be for operation in oil and water mixtures comprising ≤50% water by weight of the mixture, such as ≤40 wt %, or ≤30 wt %, preferably ≤20 wt % or ≤10 wt %.

The fuel tank of the present invention may comprise an oil and water mixture, suitably a kerosene and water mixture, wherein the mixture comprises ≤50% water by weight of the mixture, such as ≤40 wt %, or ≤30 wt %, preferably ≤20 wt %, such as ≤10 wt %.

The separation membrane may be suitably used to separate water from oils, such as water in oil, such as kerosene/water, such as pentane/water, such as cyclopentane/water, such as hexane/water, such as cyclohexane/water, such as heptane/water, such as cycloheptane/water, such as octane/water, such as cyclooctane/water, such as nonane/water, such as cyclononane/water, such as decane/water, such as cyclodecane/water, such as undecane/water, such as cycloundecane/water, such as dodecane/water, such as cyclododecane/water, such as hexaclecane/water, such as petrol/water, such as diesel/water, such as vacuum pump oil/water.

For the purpose of the present invention, an aliphatic group is a hydrocarbon moiety that may be straight chain (i.e. unbranched), branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof. The term “(hetero)aliphatic” encompasses both an aliphatic group and/or a heteroaliphatic group.

An aliphatic group is optionally a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅ aliphatic, optionally a C₁₋₁₂ aliphatic, optionally a C₁₋₁₀ aliphatic, optionally a C₁₋₈ aliphatic, such as a C₁₋₆aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is optionally a “C₁₂₀ alkyl group”, that is an alkyl group that is a straight or branched chain with 1 to 20 carbons. The alkyl group therefore has 1, 2, 3. 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 12-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅ alkynyl”, optionally “C₂₋₁₂alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆alkenyl” and “C₂₋₆alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantine and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

An aryl group or aryl ring is a monocyclic or polycyclic ring system having from 5 to 20 carbon atoms, wherein at least one ring in the system is aromatic and wherein each ring in the system contains three to twelve ring members. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₈₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

As used herein, unless otherwise expressly specified, all numbers such as those expressing values, ranges, amounts or percentages may be read as if prefaced by the word “about”, even if the term does not expressly appear. The term “about” when used herein means +/−10% of the stated value. Also, any numerical range recited herein is intended to include all sub-ranges subsumed therein. Singular encompasses plural and vice versa. For example, although reference is made herein to “a” substrate, “a” hydrophilic agent, “a” superhydrophilic agent, and the like, one or more of each of these and any other components can be used. As used herein, the term “polymer” refers to oligomers and both homopolymers and copolymers, and the prefix “poly” refers to two or more. Including, for example and like terms means including for example but not limited to. Additionally, although the present invention has been described in terms of “comprising”, the processes, materials, and coating compositions detailed herein may also be described as “consisting essentially of” or “consisting of”.

Where ranges are provided in relation to a genus, each range may also apply additionally and independently to any one or more of the listed species of that genus. For example, the invention may comprise a first active layer formed from a first active layer coating composition wherein the composition comprise from 0.01 to 0.5% of a hydrophilic agent, by total weight of the composition, which hydrophilic agent comprises graphene oxide in an amount such that the composition comprises from 0.01 to 0.5% of graphene oxide, by total weight of the composition. A further example may be wherein the composition comprises from 0.01 to 0.5% of a hydrophilic agent, by total weight of the composition, which hydrophilic agent comprises graphene oxide and boron nitride in an amount such that the composition comprises ≥0.01% of graphene oxide, by total weight of the composition. Further, for example, the composition may comprise from 0.01 to 5% of a hydrophilic agent, by total weight of the composition, which hydrophilic agent may comprise graphene oxide and boron nitride in an amount such that the composition comprises ≤0.4% of graphene oxide, by total weight of the composition. Further examples of the abovementioned include ranges provided for the superhydrophilic agent, intermediate layer components, etc and all associated species, sub-genera and sub species.

All of the features contained herein may be combined with any of the above aspects in any combination.

For a better understanding of the invention, and to show how embodiments of the same may be carried into effect, reference will now be made, by way of example, to the following experimental data.

### EXAMPLES

### Example 1

Formulation A: 100kg of a mixture containing 42.2 kg bis(trimethylsilyloxy)methylsilylpropyl glycerol methacrylate (SIMA) and 29.5 kg of 2-methacryloyloxyethyl phosphorylcholine (MPC) in isopropyl alcohol.

Formulation B: 100 kg of a mixture containing 1.7 kg triethyleneglycol dimethacrylate (TEGDMA) and 1.5 kg (3 mol % to total momomer in formulation A) 2,2-Dimethoxy phenylacetophenone (DMPA) in isopropyl alcohol.

Formulation C: 10% 3-Aminopropyltrimethoxysilane in 50 v/50 v water/ethanol

50 kg of Formulation A was mixed with 50kg of Formulation B, and the mixture was then subjected to the elimination of oxygen by bubbling with argon gas to form Formulation D.

An asymmetric polyethersulfone membrane with a Sterlitech polyethylene terephthalate/polypropylene backing having pore size of 0.05 um was treated on the polyethersulfone side with oxygen plasma for 30 seconds. The treated substrate was then coated with Formulation C using doctor blade coating at a speed of 10 m/min with a gauge gap of 15 um. The treated membrane was then heated at 110° C. for 10 minutes.

The treated membrane was then coated with Formulation D using doctor blade coating, having a gauge gap of 20 um at a speed of 10 m/min. The coated membrane was then subjected to UV light irradiation using an ultra-high-pressure mercury lamp (UVL-400HA, Riko-kagaku Sangyo, Funabashi, Japan) for 1 minutes. The intensity of the UV light was at around 5 mW/cm² with the wavelength in the range of 300-400 nm, achieved by a filter. The treated membrane was then immersed in a mixture of isopropyl alcohol and water (50 v/50 v) for 24 hours to ensure the complete removal of residual low molecular weight compounds.

The membrane was then dried at 40° C. for 4 hours.

The prepared dry membrane, with crosslinked MPC-SiMA superhydrophilic layer, was then cut into round samples of 5 cm in diameter and inserted into a drainage valve of a tank. The passage of kerosene through the valve from inside to outside of the tank was via the membrane, with the coated face of the membrane facing the inside of the tank. The valve had a close-open mechanism. Kerosene was then added to the tank, after which the valve was opened. The tank was pressurised to 3 bar which was maintained throughout the rest of the test. No kerosene passed across the membrane. After 36 hours water was added to the kerosene in the tank. The water almost immediately drained through the membrane exiting out of the tank via the membrane. The kerosene remained inside the tank after all the water had fully drained. All the kerosene remained within the tank with no leakage for at least 36 hours after which point the test was stopped.

### Example 2

Formulation A: 2 wt % aqueous solution of sodium carboxymethyl cellulose with a degree of substitution 0.77, with average molar mass Mw=220k.

Formulation B: 2 wt % aqueous solution of poly(ethylene glycol), with Mw=1520

Formulation C: 4 wt % Citric acid as crosslinker in water

Formulation D was obtained by mixing 10 kg of Formulation B and 90 kg of Formulation A.

A 100 kg mixture containing 97.5 wt % formulation ID and 2.5 wt % formulation C was prepared and then coated on a 1 um (equivalent pore size) nonwoven polyester terephthalate (PET) substrate, using a RK doctor blade coating equipment, at a coating speed at 15 m/min, with a controlled gap of 10 um. The coated membrane was then heated at 80°C. for 4 hours to give a superhydrophilic active layer comprising citric acid crosslinked sodium carboxymethyl cellulose enhanced by polyethylene glycol).

The prepared dry membrane was then cut into round samples of 5 cm in diameter and inserted into a drainage valve of a tank. The passage for kerosene through the valve from inside to outside of the tank was via the membrane, with the coated face of the membrane facing the inside of the tank. The valve had a close-open mechanism. Kerosene was then added to the tank. After that the valve was opened. No kerosene passed across the membrane. A pressure of 1 bar was applied through the rest of the test. After 36 hours water was added to the kerosene in the tank. The water almost immediately drained through the membrane exiting out of the tank via the membrane. The kerosene remained inside the tank after all the water had fully drained under 1 bar. All the kerosene remained in the tank for at least 36 hours after which point the test was stopped.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A separation membrane comprising a porous substrate layer and an active layer arranged over at least a part of the substrate layer, wherein the active layer is at least partially crosslinked and comprises a superhydrophilic agent.

2. The membrane according to claim 1, wherein the porous substrate layer comprises a polymeric substrate, a polymeric substrate containing inorganic filler, a ceramic substrate, a composite substrate, a metal substrate, an inorganic substrate, inorganic-organic substrate, and/or a casted substrate.

3. (canceled).

4. The membrane according to claim 1, wherein the porous substrate layer comprises a polyethylene terephthalate-based (PET) membrane.

5. (canceled).

6. The membrane according to claim Jany preceding claim, wherein the porous substrate layer has a surface roughness, Rz, of nm.

7. (canceled)

8. (canceled)

9. (canceled)

10. (canceled)

11. (canceled)

12. (canceled)

13. (canceled)

14. The membrane according to claim 13, wherein the superhydrophilic agent comprises a (co)polymer or precursor thereof selected from a polyelectrolyte, a polymer salt, and/or an ionised polymer, or precursor thereof.

15. The membrane according to claim 13, wherein the superhydrophilic agent comprises a (co)polymer in the form of a hydrogel, or is operable to form a hydrogel upon contact with water.

16. (canceled)

17. The membrane according to claim 1, wherein the superhydrophilic agent comprises a (co)polymer with a molecular weight (Mw) of ≥6,000 g/mol.

18. (canceled)

19. (canceled)

20. The membrane according to claim 1, wherein the crosslinker comprises a multi-functional acrylic or vinyl monomer, a divalent metal ion, multi-functional carbodiimide, multi-functional aziridine, silane; multi-functional epoxide and/or multi-functional isocyanate, or residue thereof.

21. (canceled)

22. The membrane according to claim 1, wherein the crosslinking density is at least 2 molar % of the crosslinkable functional groups.

23. The membrane according to claim 1, wherein the superhydrophilic agent comprises a polyelectrolyte (co)polymer selected from a (meth)acrylic acid (co)polymer; and/or a styrene sulfonate acid (co)polymer, wherein at least part of the acid is in the form of a suitable salt.

24. The membrane according to claim 1, wherein the superhydrophilic agent comprises a polyelectrolyte copolymer selected from polystyrene-alt-maleic acid) sodium, chitosan-g-poly(acrylic acid) copolymer sodium; 2-propenoic acid, 2-methyl, polymer with sodium; and/or 2-methyl-2((1-oxo-2-propen-1-yl)amino)-1-propanesulfonate.

25. (canceled)

26. The membrane according to claim 1, wherein the membrane comprises a first active layer that comprises a hydrophilic agent, and a second active layer that comprises the superhydrophilic agent.

27. (canceled)

28. (canceled)

29. (canceled)

30. The membrane according to claim 26, wherein the hydrophilic agent comprises a (co)polymer formed from monomers comprising vinylpyrrolidone, vinyl alcohol, allylamine, ethylenimine, allylammonium chloride, vinylamine, lysine, chitosan, silane-based and/or its derivatives; acrylics; acrylamide; and/or hydroxyalkylmethacrylate, and copolymers thereof.

31. The membraneaccording to claim 26, wherein the hydrophilic agent is selected from a graphene-based material.

32. (canceled)

33. (canceled)

34. (canceled)

35. The membrane according to claim 1, wherein the superhydrophilic agent comprises from a polystyrene sulphonate salt) and/or a polyacrylic acid salt.

36. (canceled)

37. The membrane according to claim 1, wherein the membrane comprises an intermediate layer between the substrate and the active layer.

38. (canceled)

39. The membrane according to claim 37, wherein the intermediate layer comprises a silane-based adhesion promoter.

40. (canceled)

41. (canceled)

42. (canceled)

43. (canceled)

44. A method of producing the separation membrane of claim 1, the method comprising the steps of:
a. optionally, preparing a substrate by treating the substrate with physical rinsing, chemical treatment, radiation treatment, plasma treatment, and/or thermal treatment;
b. optionally, contacting the substrate with an intermediate layer coating composition to form an intermediate layer;
c. optionally, contacting the substrate with a coating composition comprising a hydrophilic agent or precursor thereof to form an active layer;
d. optionally, drying the active layer;
e. optionally, contacting the active layer with an intermediate layer coating composition to form an intermediate layer;
f. contacting the optionally coated substrate with a coating composition comprising a superhydrophilic agent or precursor thereof to form an active layer;
g. optionally, drying the further active layer;
wherein the active layer comprising the superhydrophilic agent is at least partially crosslinked.

45. (canceled)

46. A method of separating oil and water, comprising the steps of:
a. selecting a membrane comprising a porous substrate layer and an active layer arranged over at least a part of the substrate layer, wherein the active layer is at least partially crosslinked and comprises a superhydrophilic agent, suitably a membrane according to claim 1;
b. contacting the membrane with composition comprising oil and water; and
c. effecting separation of the oil and water through the membrane,
wherein the average pore size of the substrate is selected based on the operational pressure such that the substrate has a lower average pore size at higher operational pressure to give a membrane with a water flux of ≥100 Imh/bar during separation of the oil and water through the membrane.

47. (canceled)

48. (canceled)

49. (canceled)

50. A drainage device comprising a membrane according to claim 1.

51. A fuel tank comprising a drain valve, wherein the drain valve comprises a membrane according to claim 1. 52. An automotive product or any part thereof comprising a fuel tank that comprises a drain valve, wherein the drain valve comprises a membrane according to claim 1.
